(19) United States
(12) Patent Application Publication
(10) Pub. No.: US 2022/0166302 A1
(43) Pub. Date: May 26, 2022

(54) BIPOLAR LINEAR STEP MOTOR

(71) Applicant: Lin Engineering, Inc., Morgan Hill, CA (US)

(72) Inventors: Ted T. Lin, Saratoga, CA (US); Richard L. Badgerow, Watsonville, CA (US)

(73) Assignee: Lin Engineering, Inc., Morgan Hill, CA (US)

(21) Appl. No.: 17/329,289

(22) Filed: May 25, 2021

Related U.S. Application Data
(60) Provisional application No. 63/116,313, filed on Nov. 20, 2020.

(51) Int. Cl. H02K 41/03

(52) U.S. Cl. CPC H02K 41/031

(57) ABSTRACT

A linear stepping motor has a linear stator and a rod movable longitudinally within the stator. The rod has alternating permanent magnets and spacer disks, successive magnets being N-S opposed. A rod pitch equals twice the magnet width plus twice the disk width. The stator has a stack of stator groups associated with the drive phases. Each stator group is a pair of stator poles of opposite magnetic polarity separated by one-half rod pitch. Adjacent poles in different groups are separated by a [(n+1)/2n] rod pitch, where n is the number of drive phases. Each pole may be an annular disk yoke with a plurality of inward projecting salient pole pieces terminating in pole shoes. Conductive windings for a stator group proceed successively around each pole piece in one direction for a first pole of the group and then successively in a reverse direction for a second pole of the group.

### CROSS-REFERENCE TO RELATED APPLICATION

This application claims priority under 35 U.S.C. 119(e) from U.S. provisional application 63/116,313 filed Nov. 20, 2020.

### TECHNICAL FIELD

The invention relates to motors designed to provide direct drive for linear motion.

### BACKGROUND ART

Most of the linear actuators use a rotary motor with an attached lead screw. They generate a significant force but cannot move with high speed. One full turn of the motor only produces a small linear displacement of the lead screw.

There are many linear motors available in the industry. Because most of them are designed with a closed-loop control system, they are not popular in the marketplace due to high cost.

Most conventional linear motor designs are using bobbin coil windings, as represented in FIG. 1. Each bobbin U, V, W, etc. arranged in series in a pipe-shaped stator member has a conductive winding coil that electromagnetically drives a movable rod 25. However, these cannot provide enough Ampere-Turns to collect the strong magnetic field from the rod 25. Thus, many coils must be installed in one unit.

In a paper by A. H. Zamanian and E. Richer, “Identification and Compensation of Cogging and Friction Forces in Tubular Magnetic Linear Motors”, Proc. of the ASME 2017 Dynamic Systems and Control Conference, Oct. 11-13, 2017, paper DSCC2017-5180, a tubular slotted permanent magnet motor, as seen in FIG. 2, comprises a slider or translator member 11 with a set of radial permanent magnets 13 therein with a certain pole pitch P and an stator member 15 with armature coils 17 and ferromagnetic armature slots 18 with a certain slot pitch S. An electronic servo controller unit 19 energizes the armature coils 17 to slide the translator member 11 within the stator 15. As discussed by the authors, cogging and friction forces are identified for the development of a switching feedback controller capable of reducing the energy of undesired disturbances of translator movement to achieve a constant speed.

With reference to FIG. 3, LinMot® industrial linear motors by NTI AG (Switzerland), are electromagnetic direct drives in tubular form. The linear motion is produced purely electrically and wear-free, without any intermediate coupling of mechanical gearboxes, spindles, or belts. The linear motor 21 consists of just two parts: the slider 23 and the stator 24. The slider 21 is made of neodymium magnets 26 that are mounted in a high-precision stainless steel tube 27. The stator 24 contains the motor windings 28, along with bearings for the slider, position capture sensors, and a microprocessor circuit 29 for monitoring the motor. The internal position sensor 30 measures and monitors the current position of the linear motor not only when it is stopped, but also during the motion. Deviations in position are detected immediately and reported to the upper-level controller. LinMot® linear motors can be positioned freely within the entire range of the stroke. In addition, both the travel speed and the acceleration can be controlled precisely. For more complex motions, arbitrary travel profiles can be saved as curves in the servo drive and executed by the motor at the desired speed.

With reference to FIG. 4, linear shaft motors from Nippon Pulse America, Inc. are a brushless, high-precision, direct drive linear servo motor with a tubular design. The motor 31 is a direct drive linear servomotor, which consists of a magnetic shaft 33 and coil assembly (forcer) 34 with a wound coil 35 that is driven and controlled by the flow of current. They can replace ball-screws, pneumatics, U-shaped motors and other linear motion systems. More than one forcer can be used in conjunction with a single shaft provided the forcers do not physically interfere with each other. Two forcers may be tied together and driven with one drive to double the output force. Because the forcer coil 35 completely wraps around the shaft's internal magnets 32, all the motor's magnetic flux is efficiently used.

With reference to FIG. 5, U.S. Pat. No. 6,756,705 to Pulford, Jr. describes a linear stepper motor comprising an annular stator structure 32 and an axially extending, cylindrical, permanent magnet shaft 30 extending coaxially through the annular stator structure. Axially alternating N and S poles are defined circumferentially in an outer periphery of the permanent magnet shaft 30. The stator structure 32 includes with an annular stack of pole pieces 50-56 with annular coiled bobbins 44 that when energized direct magnetic flux to linearly drive the shaft.

### SUMMARY DISCLOSURE

A direct linear stepper motor is provided that comprises a longitudinal linear stator, and a rod within the stator that is movable in a first longitudinal direction between successive detent step positions.

The rod has pairs of N-S magnetically opposed permanent magnets longitudinally alternating with magnetically permeable spacer disks (e.g., of steel) between each of the magnets. The rod may be in the form of a hollow tube with the permanent magnets and spacer disks stacked alternately within the tube. The permanent magnets and spacer disks all have the same longitudinal width or thickness. Thus, the rod will be characterized by a rod pitch that is equal to twice the permanent magnet width plus twice the disk width. The linear stator is separated from the rod by an air gap in a second radial or transverse direction.

The motor's longitudinal stator has stator poles in the form of a longitudinal stack of two or more paired electromagnet coils of opposite polarity (each pair referred to as a stator group), with at least one stator group for each drive phase. Each group represents an independent phase. A two-phase motor will have at least two stator groups (four stator coils), while a four-phase motor will have at least four stator groups (eight stator coils). The number could be multiplied if greater torque is required, but one stator group per drive phase should be sufficient for most purposes.

Each stator pole may be in the form of a generally annular or ring-shaped disk armature yoke, possibly of laminated construction, with a plurality (e.g., six) of radially inward projecting salient pole pieces terminating in pole shoes and with conductive windings around those pole pieces. When the windings for a given drive phase are energized with electrical current, a magnetic flux path will be created that passes from the salient pole pieces through the pole shoes and across the air gap to interact magnetically with the rod. This will drive the rod to the next specified linear step position and then hold it as long as the windings remain energized in that phase. Each pole piece has its own windings to provide a strong magnetic force to hold the rod in the radius direction. The windings in any given stator pole proceed in a consistent direction around the pole pieces such that the electromagnetic coils, when energized by an electric drive current, direct a common magnetic polarity (either N or S) radially through the pole pieces of that stator pole onto the pole shoes to interact across the air gap with the rod. For stator poles of same phase but opposite polarity (pole pairs in the same stator group), the coil windings proceed in opposite directions around the salient pole pieces. Thus, one pole in a stator group of given phase develops all magnetic N poles toward the rod, while the other pole in the stator group always develops the opposite magnetic S pole toward the rod.

In the stator, magnetically permeable back spacers are disposed between pairs of the annular armature disks of same phase but opposite polarity, so those disks are longitudinally separated from one another by a distance equal to one rod permanent magnet width. Thus, the pairs of stator poles in a stator group have a center-to-center longitudinal separation distance equal to one-half rod pitch. These back spacers also complete the magnetic circuit between opposite polarity poles of the same stator group.

Nonmagnetic separators are disposed between annular armature disks of different phase stator groups. The longitudinal width of the separators depends upon the number of drive phases in the linear motor. For a two-phase motor, the separators have a width equal to two rod permanent magnet widths, providing a center-to-center separation between adjacent stator poles of different drive phase (i.e., in different stator groups) equal to three-fourths rod pitch. For a four-phase motor, the separators have a width that provides a center-to-center pole separation between adjacent stator groups equal to five-eighths rod pitch. More generally, adjacent stator poles in different stator groups and therefore different drive phases are separated by a center-to-center longitudinal distance equal to [(n+1)/2n] rod pitch, where n is the number of drive phases.

Because of the pairing of magnetically opposed stator poles in stator groups and the provision of nonmagnetic separators between adjacent groups, the stator groups of different drive phase are ensured to be magnetically decoupled from one another. The stator position sequence is (A, A−), (B, B−), . . . , where the parentheses indicate the respective stator groups. This is a decoupled phase design, wherein A and A− stator poles create an A-phase closed flux path, and the B and B− stator poles create a separate B-phase closed flux path isolated from the A-phase flux path with no interference from the other phase. Likewise, for the additional (C, C−) and (D, D−) stator poles in a four-phase motor, each stator group is magnetically decoupled from every other stator group of a different drive phase. A benefit of this decoupled design is fully utilizing the magnetic fluxes of both stator poles and rod permanent magnets for maximum holding force. With the given stator pole separations, the detent step position sequence in a two-phase motor is A, B, A−, B−, (repeat) . . . , where one full linear step equals ¼ of the rod pitch. In a four-phase linear stepper, the successive full step positions are separated by ⅛ of the rod pitch.

Rather than using bobbin coils to generate the magnetic flux to collect the flux from the permanent magnet from the rod, a multiple stator pole winding is designed to do the same function but more effectively. More area is available for windings compared to the bobbin coil design, so the linear stepper can develop more Ampere-Turns with less current. And splitting the one bobbin coil to a multiple pole stator winding will reduce the winding inductance for fast current rise time. Thus, a high-speed motion can be achieved. Compared to the conventional bobbin coil windings, the invention generates more magnetic force with less inductance that can move the rod at high speed with open loop control.

### BRIEF DESCRIPTION OF THE DRAWINGS

FIG. 1 is an exploded schematic perspective a first prior art embodiment of a linear motor.

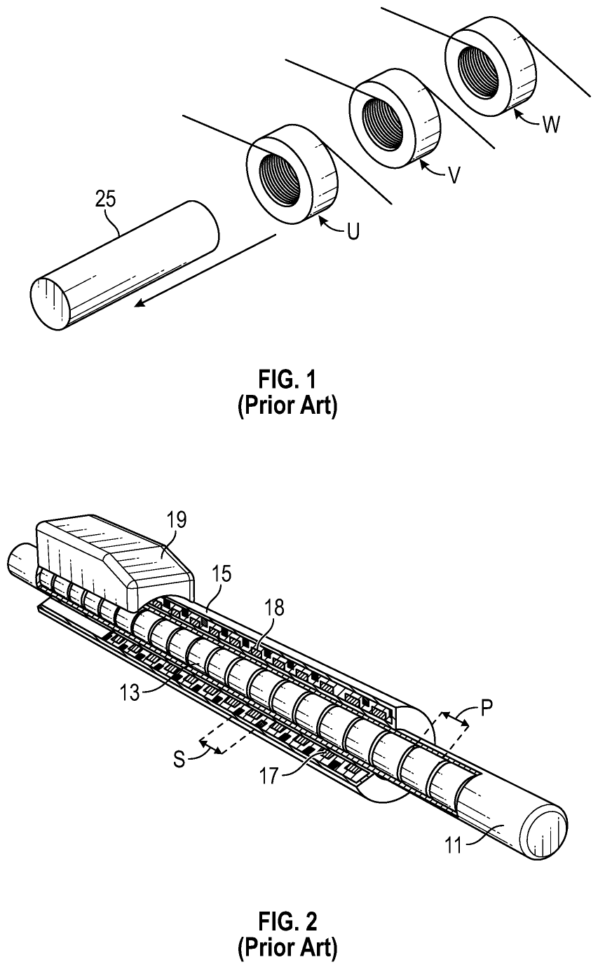

FIG. 2 is a cutaway perspective view of a second prior art embodiment of a linear motor.

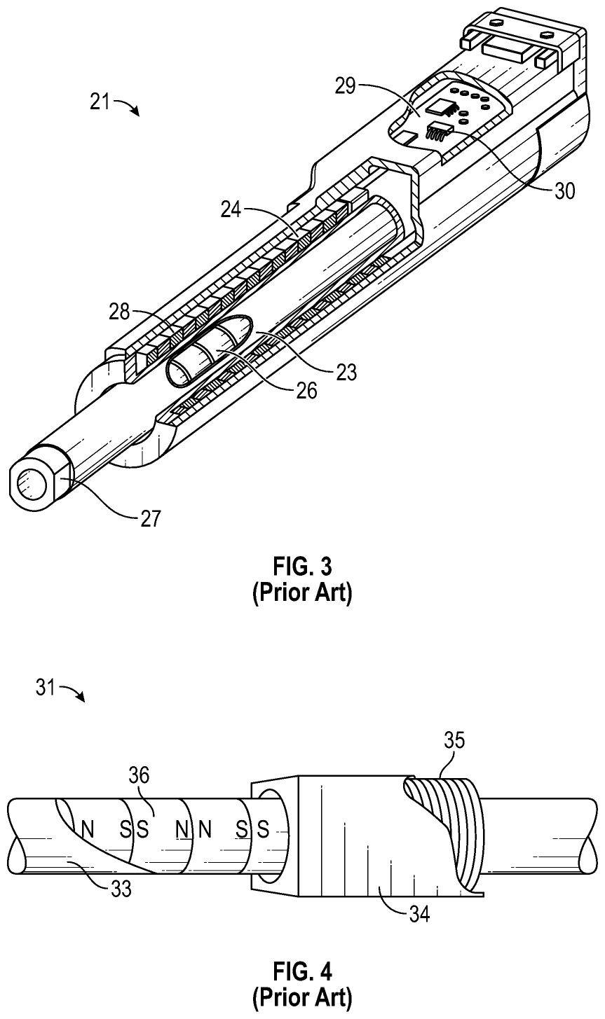

FIG. 3 is a cutaway perspective view of a third prior art embodiment of a linear motor.

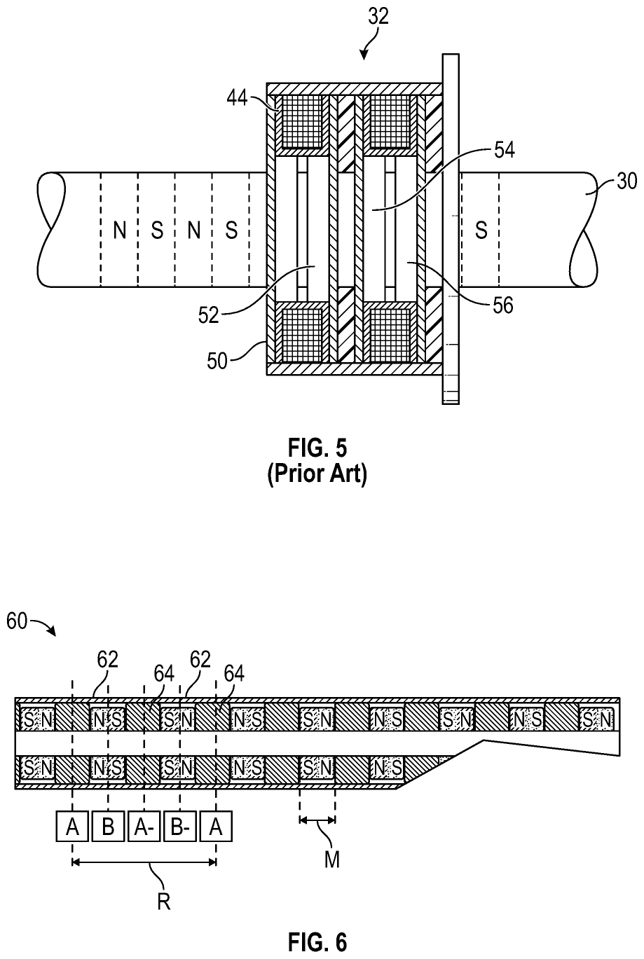

FIG. 4 is a cutaway perspective view of a fourth prior art embodiment of a linear motor.

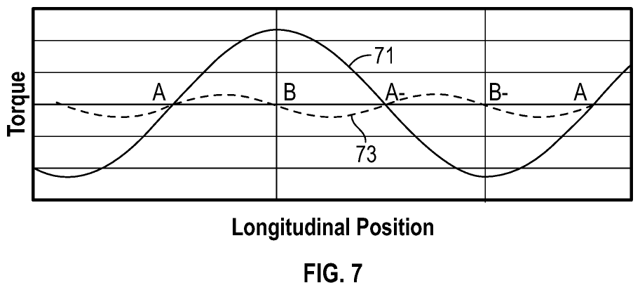

FIG. 5 is a sectional side plan view of a fifth prior art embodiment of a linear motor.

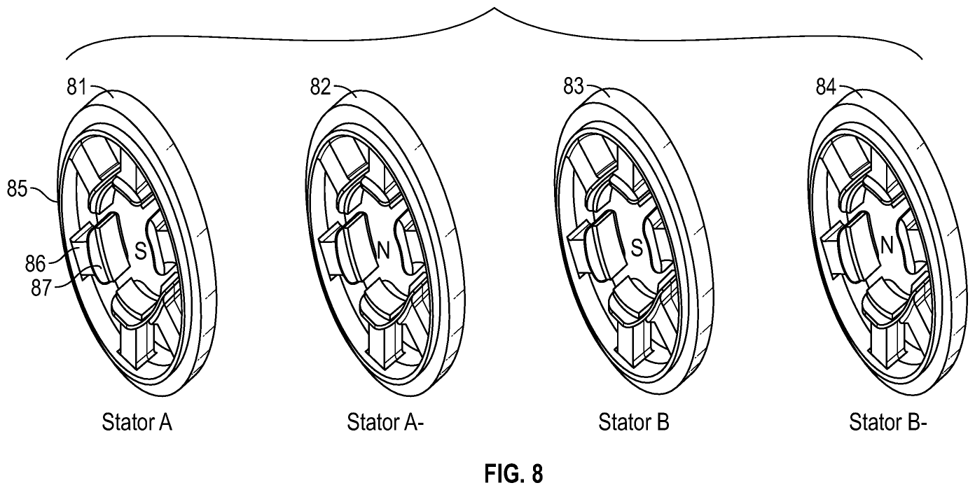

FIG. 6 is a sectional side plan view of a movable rod or shaft of a linear stepping motor in accord with the present invention.

FIG. 7 is a graph of holding force and detent force as a function of longitudinal position of the rod of FIG. 6 in a linear stepping motor of the present invention.

FIG. 8 is an exploded perspective view of four annular disk armature yokes for stator poles of respective A, A−, B and B− drive phases for a two-phase linear stepping motor of the present invention.

FIGS. 9A and 9B are sectional side plan views of a two-phase linear stepping motor of the present invention with movable rod as in FIG. 6 and stator poles with yokes as in FIG. 8, wherein FIG. 9A shows the full step position when the A and A− group of stator poles are energized, and FIG. 9B shows the full step position when the B and B− group of stator poles are energized.

FIGS. 10A-10C and 11A-11C are sectional side plan views of a two-phase linear stepping motor in accord with the present invention in respective A full step position, AB half-step position, and B full step position.

FIG. 12 is a schematic wiring diagram showing the path of conductive windings around the various stator poles of the present invention in a bobbin-less multiple stator pole winding scheme.

FIG. 13 is an exploded perspective view of the various parts of a linear step motor as in FIGS. 6-12.

FIG. 14 is an exploded perspective view of eight annular disk armature yokes for stator poles of respective A, A−, B, B−, C, C−, D and D− drive phases for a four-phase linear stepping motor of the present invention, analogous to the two-phase motor stator poles of FIG. 8.

FIG. 15 is a graph, analogous to FIG. 7, of holding force and detent force as a function of rod longitudinal position in a four-phase linear stepping motor of the present invention using the stator poles of FIG. 14.

FIGS. 16A-16H are sectional side plan views of a four-phase linear stepping motor in accord with the present invention in successive full and half step positions.

### DETAILED DESCRIPTION

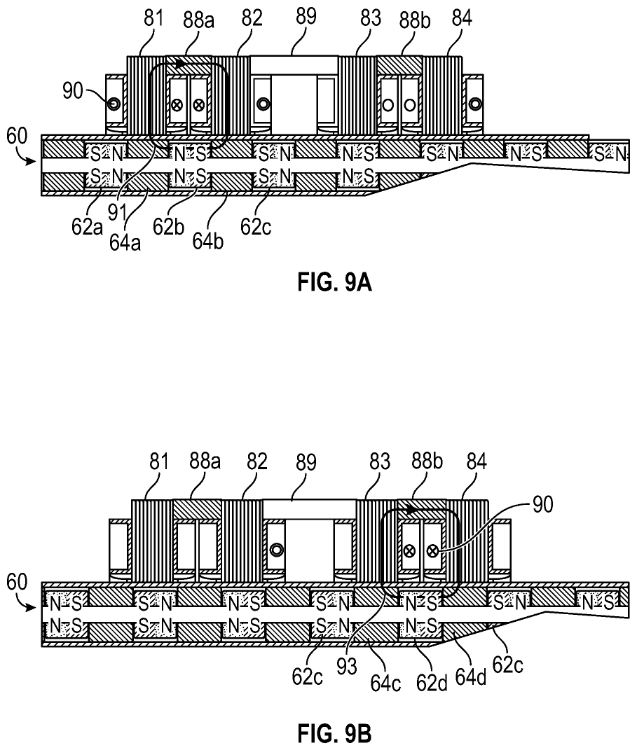

With reference to FIG. 6, a rod or shaft 60 has a series of permanent magnet disks 62 assembled with the N-S magnetic polarity against each other and separated from each other by magnetic permeable steel disks 64. Each of the magnets 62 has a magnet width M and each of the steel disks has a disk width D that is equal to the magnet width, D=M. The rod pitch R is therefore defined by two permanent magnet disks 62 and two steel disks 64, R=2M+2D.

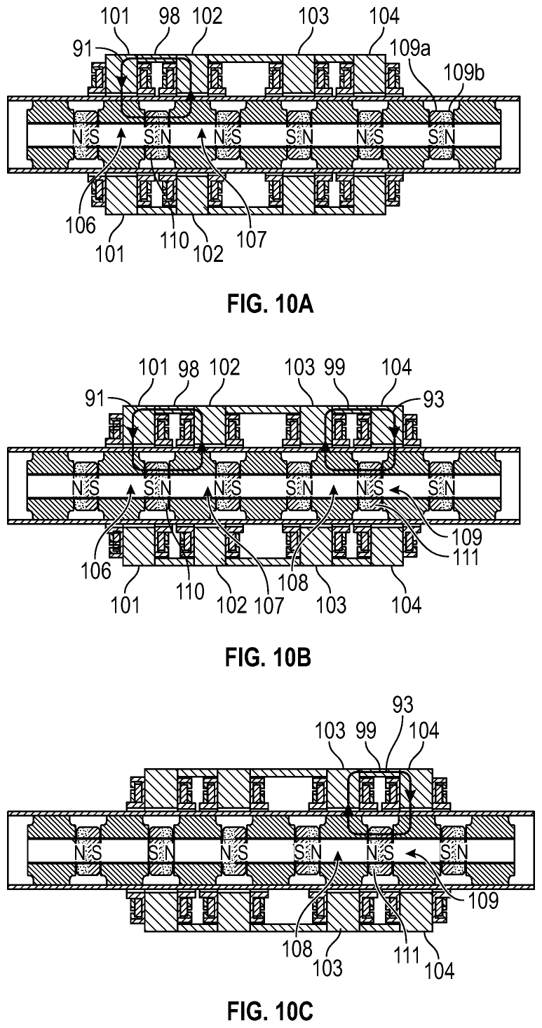

In FIG. 7, the movable rod or shaft 60 will experience different holding and detent torques as a function of the rod's longitudinal position, where the full detent step positions A, B, A− and B− are distributed at successive one-quarter pitches across the full rod pitch R as shown in FIG. 6. In a two-phase linear stepping motor, the holding force 71 (shown here when the B phase stator pair is energized) has a periodicity along the rod equal to the rod pitch R, while the detent force 73 is a second harmonic with a periodicity equal to R/2. The detent positions ensure that precise full step (and half-step) positions are provided without the need for any position encoder feedback system. The linear stepping motor can operate as an open loop system.

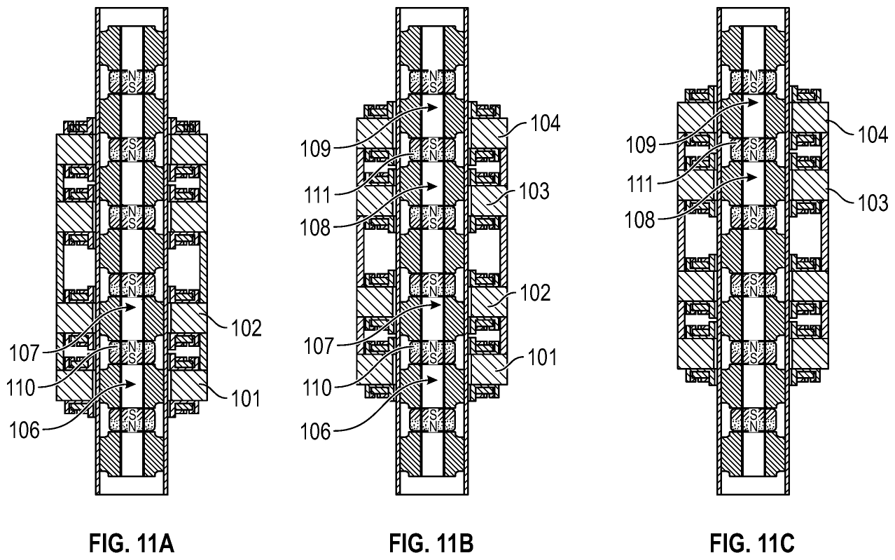

As seen in FIG. 8, a two-phase linear stepper will have two pairs of stator poles for a total of four stator poles 81-84 (or optionally, multiples thereof). Each stator pole is in the form of an annular disk, specifically as a ring-shaped armature yoke 85 with a plurality (e.g., six) salient pole pieces 86 extending radially inward from the outer ring of the armature yoke 85 and terminating in respective pole shoes 87, one shoe per pole piece. The pole shoes 87 help hold conductive windings (absent in FIG. 8) in place around the pole pieces 86.

The stator yoke or core 85 is composed of a soft magnetic material, allowing it to be easily magnetized and demagnetized as the stator windings around various stator poles are energized and de-energized in some specified sequence. This is a metallic permeable alloy with an intrinsic coercivity less than 1 kA·m⁻¹ and little magnetic remanence, such as any of iron, silicon steel (with up to 3% silicon), moly-permalloy (e.g., 15Fe-80Ni-5Mo), amorphous iron-cobalt, and soft ferrites. Low core losses (such as from eddy currents), high frequency response, and saturation flux density are some factors in the selection, depending upon whether holding torque or switching speed are foremost. Additionally, the stator yoke 85 is typically a laminated structure built up from a stack of thin plates. The back-iron or outer portion of the yoke 85 is annular, although not necessarily circular in cross-section. However, the pole shoes 87 have cylindrically concave faces lying on a common circle that is co-axial with the movable rod to present an airgap between rod and shoes that is substantially equidistant around the rod.

Windings around the pole pieces 86 of any one stator pole will proceed in the same direction so that when the pole is energized with drive current through the windings a common electromagnetic polarity (either N or S as shown) will be presented radially through the pole pieces 86 onto the pole shoes 87. Stator poles 81 and 83 of phases A and B may present a S magnetic polarity onto its respective pole shoes 87, while stator poles 82 and 84 of phases A− and B− may present a N magnetic polarity onto its respective shoes 87. The pair 81 and 82 of phases A and A− in a group of stator poles will have one N magnetic pole and one S magnetic pole. Likewise, the pair 83 and 84 of phases B and B− in a group of stator poles will have one N magnetic pole and one S magnetic pole.

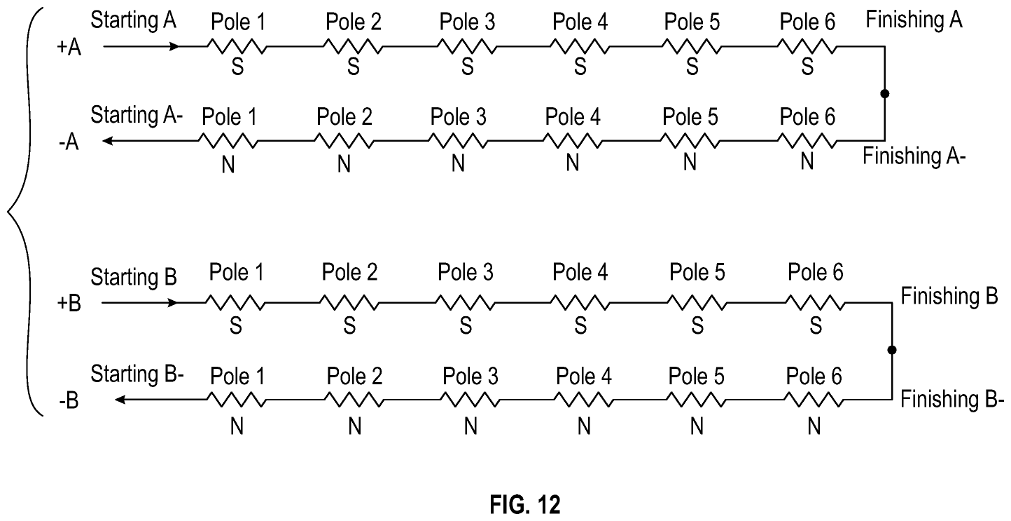

Turning now to a linear stepping motor with both a movable rod as in FIG. 6 and a longitudinal linear stator having stator poles constructed as in FIG. 8, FIG. 9A shows the case when the phase A and A− group of stator poles are energized, while FIG. 9B shows the case when the phase B and B− group of stator poles are energized. The movable rod or shaft 60 is only partially shown. It can extend to any length, provided it is composed of permanent magnets 62 alternating with magnetically permeable spacer disks 64, all of equal longitudinal width, and where the successive permanent magnets 62 are N-S magnetically opposed to one another. As such, each space disk 64 adjoins two magnets 62 of the same facing magnet polarity N or S.

In FIG. 9A, the stator poles 81-84 are spaced apart by specified longitudinal distances. Specifically, poles 81-82 in the same group with the same drive phase A and A− are longitudinally separated by a center-to-center distance equal to one-half rod pitch (where the rod pitch is equal as before to two magnet widths plus two spacer disk widths). This specific 0.5-pitch spacing is facilitated by a back spacer 88a of magnetically permeable material (such as the same material as the yoke) with a width equal to that of each of the rod permanent magnets and steel disks. Whenever the windings 90 around the pole pieces of the stator poles 81 and 82 are energized with electrical drive current, a magnetic field will be created with a magnetic flux path 91 that proceeds in a loop from the magnetic N pole shoes of stator pole 82 across the air gap to the corresponding rod spacer disk 64b that is adjacent to S facing poles of permanent magnets 62b and 62c of the rod, then through the permanent magnet 62b from S to N poles to the rod spacer disk 64a that is adjacent to N facing poles of permanent magnets 62a and 62b, then across the air gap to the corresponding magnetic S pole shoes of stator pole 81, and finally through the back magnetic permeable back spacer 88a to the stator pole 82 again. The back spacer 88a therefore completes the magnetic circuit in addition to ensuring the correct spacing between stator poles 81 and 82.

In FIG. 9B, poles 83-84 in the same group with the same drive phase B and B− are longitudinally separated by a center-to-center distance equal to one-half rod pitch (where the rod pitch is again equal to two magnet widths plus two spacer disk widths). This specific 0.5 pitch spacing is facilitated by a back spacer 88b, which like the back spacer 88a is of a magnetically permeable material (such as the same material as the yoke) and with a width equal to that of each of the rod permanent magnets and steel disks. Whenever the windings 90 around the pole pieces of the stator poles 83 and 84 are energized with electrical drive current, a magnetic field will be created with a magnetic flux path 93 that proceeds in a loop from the magnetic N pole shoes of stator pole 84 across the air gap to the corresponding spacer disk 64d that is adjacent to S facing poles of permanent magnets 62d and 62e of the rod, then through the permanent magnet 62d from S to N poles to the spacer disk 64c that is adjacent to N facing poles of permanent magnets 62c and 62d, then across the air gap to the corresponding magnetic S pole shoes of stator pole 83, and finally through the back magnetic permeable back spacer 88b to the stator pole 84 again. The back spacer 88b therefore completes the magnetic circuit in addition to ensuring the correct spacing between stator poles 83 and 84.

Nonmagnetic separators 90 are disposed between stator poles 82 and 83 of different phase stator groups. The longitudinal width of the separators 90 depends upon the number of drive phases in the linear motor. For a two-phase motor like that in FIGS. 9A and 9B, the separators 90 have a width equal to two rod permanent magnet widths, providing a center-to-center separation between adjacent stator poles 82 and 83 of different drive phase A and B (i.e., in different stator groups) that is equal to three-fourths rod pitch.

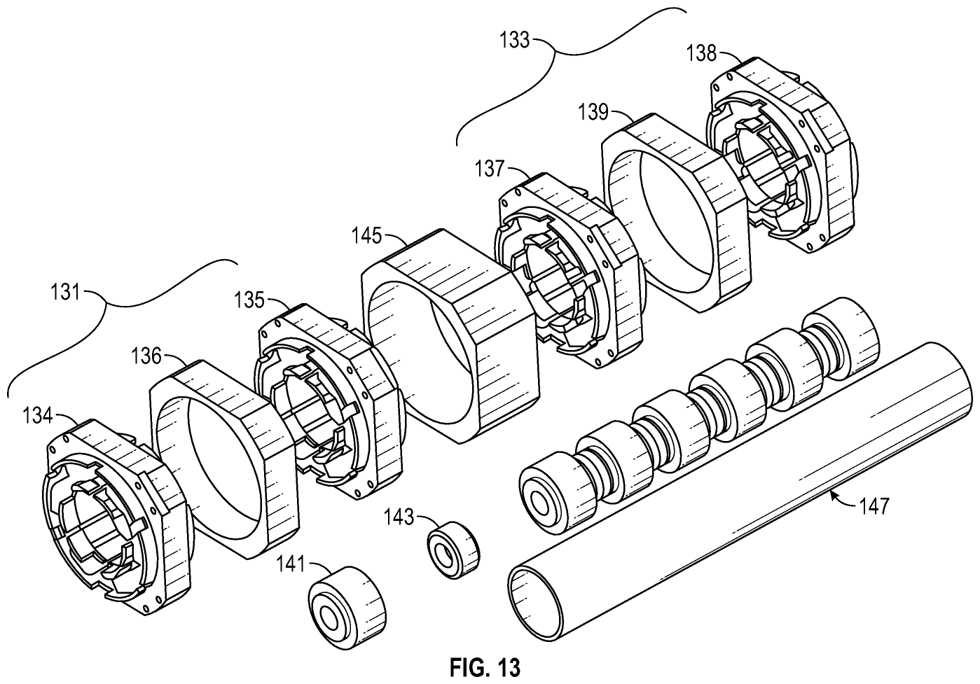

With reference to FIGS. 10A-10C and 11A-11C, the stepping (and half-stepping) linear motion of the rod is observed in successive A, AB, and B energizations of the phase windings. Each full step in this two-phase motor is equal to one-quarter rod pitch, that is the permanent magnet or rod spacer width, while each half step is half of that, i.e., ⅛ rod pitch. This can be observed by following each of the successive drive phases. In FIGS. 10A and 11A, the A-phase stator poles 101 and 102 are energized with drive current through its windings, while the B-phase stator poles 103 and 104 are not energized. A magnetic flux path 91 is created by the stator poles 101 and 102 that interacts with the spacer disks 106 and 107 and permanent magnets 110 in the rod. The S and N poles of the permanent magnets are indicated, and those magnets are seen to be alternately polarized so that S poles of two magnets both face the spacer disk 106 and N poles face the spacer disk 107. The magnetic flux path 91 forms a closed loop from stator pole 101 across the gap to spacer disk 106, through the permanent magnet 110 to the spacer disk 107, across the gap to the stator pole 102, and then through the back spacer 98 back to the stator pole 101. Because the pair of stator poles 101 and 102 in this A-phase group have a center-to-center separation equal to one-half rod pitch, the stator poles 101 and 102 will align with the rod spacer disks 106 and 107.

Similarly, in FIGS. 10C and 11C, the B-phase stator poles 103 and 104 are energized, while the A-phase stator poles 101 and 102 are not energized. The rod has fully stepped by one-quarter rod pitch relative to its position in FIGS. 10A and 11A. A magnetic flux path 93 is created by the stator poles 103 and 104 that interacts with the spacer disks 108 and 109 and permanent magnets 111 in the rod. The magnetic flux path 93 forms a closed loop from stator pole 103 across the gap to spacer disk 108, through the permanent magnet 111 to the spacer disk 109, across the gap to the stator pole 104, and then through the back spacer 99 back to the stator pole 103. Again, the pair of stator poles 103 and 104 in this B-phase group have a center-to-center separation equal to one-half rod pitch, and the stator poles 103 and 104 align with the rod spacer disks 108 and 109.

In FIGS. 10B and 11B, a half-step position is illustrated, where both the A-phase and B-phase groups of stator poles are energized with drive current through their respective coil windings. Thus, a magnetic flux path 91 is created by the stator poles 101 and 102 of the A-phase group, while an independent magnetic flux path 93 is also created by the stator poles 103 and 104 of the B-phase group. The two flux paths 91 and 93 tug equally upon the rod spacer disks 106-109, so the rod has a half-step position intermediate between that of FIGS. 10A, 11A and 10C, 11C, which is shifted one-eighth rod pitch relative to the original position in FIGS. 10A and 11A. It will be seen that none of the rod spacer disks 106-109 align perfectly with any of the corresponding stator poles because of the mutual tugging by the two stator pole phase groups, but the spacer disks 106-109 are wide enough (one-quarter rod pitch) that there is always an interaction pathway for the magnetic flux in paths 91 and 93 to complete the magnetic circuit.

Rod positions other than full and half step positions are achievable by micro-stepping, wherein drive currents through A and B phase stator poles are less than a peak amplitude of current. The position achieved will depend upon the relative amounts of current through the respective A and B phase stator pole groups. For achieving a constant amount of holding torque, the total current through both stator pole groups can be constant with only the relative amounts between them changing.

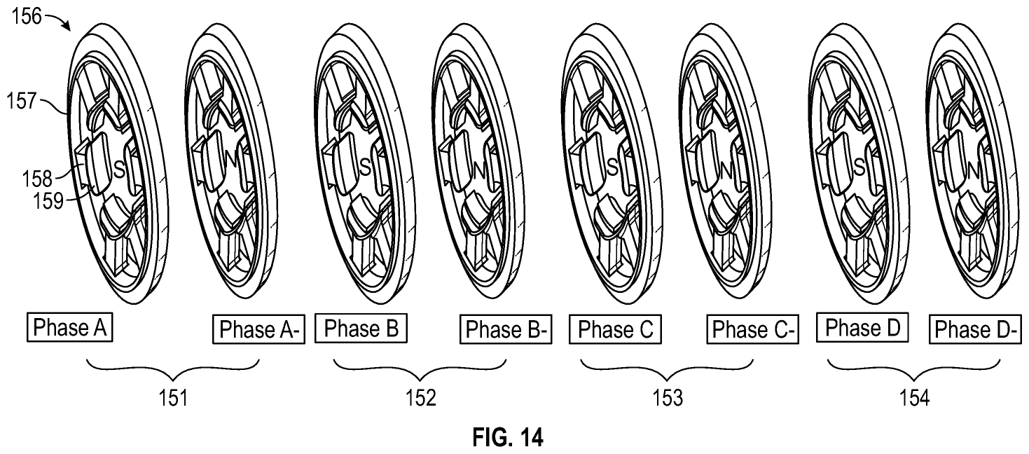

With reference to FIG. 12, a representative winding scheme is shown, in this case for an embodiment where each of the stator poles have six salient pole pieces projecting inward toward the rod. The number of pole pieces per stator pole may be chosen for the desired amount of torque and to maximize usage of the available winding space. Six pole pieces also have an advantage of greater uniformity in radial magnetic flux over fewer (e.g., four) pole pieces. Eight pole pieces could also be used if the motor is large enough to accommodate the extra windings. Rather than using bobbin coils to generate the magnetic flux to collect the flux from the permanent magnet from the rod, a multiple stator pole winding is designed to do the same function but more effectively. More area is available for windings compared to a bobbin coil design, so the linear stepper can develop more Ampere-Turns with less current. And splitting the one bobbin coil to a multiple pole stator winding will reduce the winding inductance for fast current rise time. Thus, a high-speed motion can be achieved. Compared to the conventional bobbin coil windings, the invention generates more magnetic force with less inductance that can move the rod at high speed with open loop control.

As seen in FIG. 12, the conductive windings for the A-phase stator pole group starts at a first pole piece (pole 1) then proceeds in the same direction around each successive pole piece (poles 2 through 6) of the first stator pole (A) in the pair. Thus, each of the pole pieces will present a S magnetic polarity on the face of the stator shoes that terminate each pole piece on their radially innermost ends. Next the same windings proceed in the opposite direction around each successive pole piece (poles 6 through 1) of the second stator pole (A−) in the pair. Thus, each pole piece will present a N magnetic polarity on the faces of the stator shoes for that second stator pole. If there is more than one group of paired A-phase stator poles, then the windings would continue to the pole pieces of those additional pairs of stator poles, proceeding first in one direction for the A stator poles and in the other direction for the A− stator poles of each group. All pole pieces have identical number of turns of the conductive windings to produce an identical magnetic field strength around pole pieces of each stator pole. A similar winding path for the B-phase stator group is shown, starting with the pole pieces (poles 1 through 6) of the first stator pole (B) in that group to present a magnetic S polarity and then in the opposite direction around the pole pieces (poles 6 through 1) of the second stator pole (B−) of that same group to present a magnetic N polarity. Again, all pole pieces have identical number of turns of the conductive windings to produce an identical magnetic field strength around the pole pieces of each stator pole in this second (B-phase) group. Both groups produce identical field strengths with the same amount of drive current, although when micro-stepping the two groups will have different field strengths whenever the drive currents through the two groups differ.

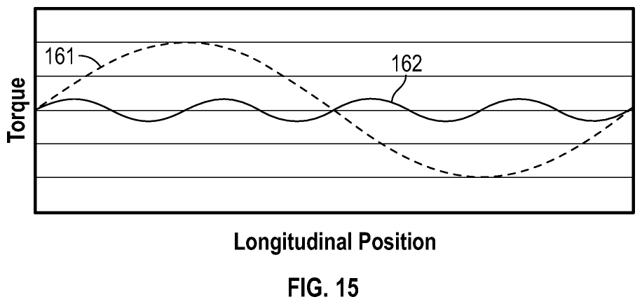

FIG. 13 in summary shows the various linear stepper motor elements in exploded perspective. An A-phase stator group 131 comprises a first (A) stator pole 134 and a second (A−) stator pole 135 which are separated by a magnetically permeable annular back spacer 136 so that the pair of stator poles 134 and 135 in the phase group will have a longitudinal center-to-center distance equal to one-half rod pitch. A B-phase stator group 133 likewise comprises a first (B) stator pole 137 and a second (B−) stator pole 138 which are separated by a magnetically permeable annular back spacer 139, again so that the pair of stator poles 137 and 138 in the phase group will have a longitudinal center-to-center distance equal to one-half rod pitch. A nonmagnetic separator 141 separates the two pole groups such that adjacent stator poles 135 and 137 of the different groups have a center-to-center separation equal to three-fourths rod pitch. A rod comprises a rod sleeve 147 holding within it permanent magnets 143 and rod spacers 145, with the magnets 143 and spacers 145 alternating and with the successive permanent magnets being oriented with opposed magnetic N-S polarities. Each spacer 145 thus faces the same N (or S) polarity from its adjacent pair of magnets 143, and successive spacers 145 present alternating N and S poles to the stator poles across an air gap. As such, the rod has a pitch equal to the longitudinal width of two magnets 143 and two spacers 145. The rod sleeve 147 with its magnets 143 and spacers 145 fit inside the center of the successive stator pole groups 131 and 133.

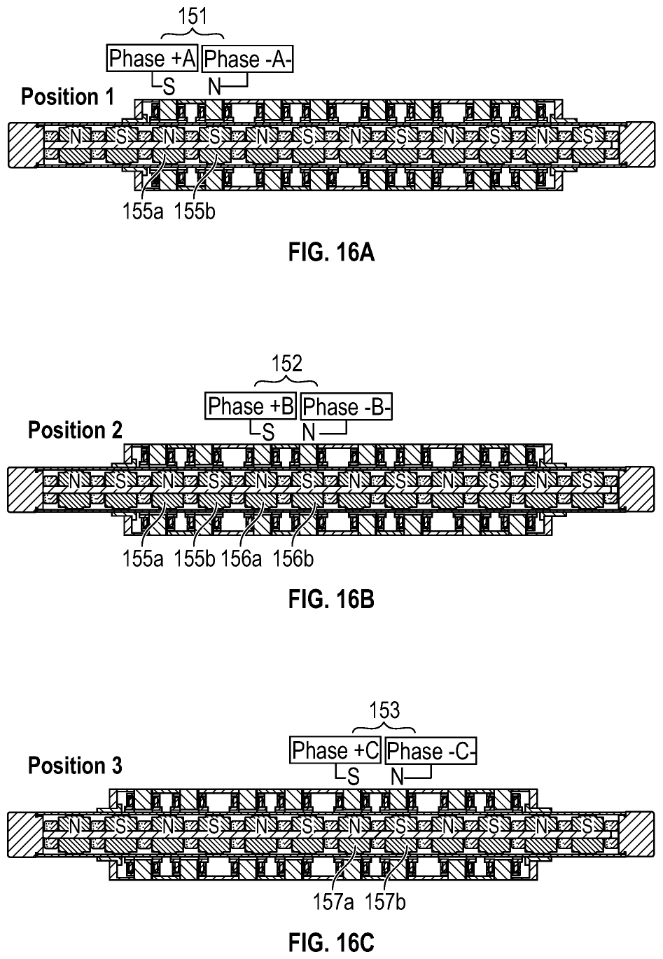

With reference to FIG. 14, additional drive phases could be provided, such a four-phase motor seen in this example with stator pole groups of designated A, B, C and D phases. Having four phases will not only improve the pulling force between the stator and the rod (although, as already noted, this could also be achieved by simply doubling the number of A and B stator groups in a two-phase motor), but also provide a finer full step distance (equal to one-eighth rod pitch instead of one-fourth rod pitch for the two-phase motor). The rod construction is the same as for a two-phase motor, only the stator construction differs.

In FIG. 14, eight stator pole cores 156 are arranged in four pairs 151-154, one pair for each stator phase group A, B, C and D. (Again, optionally, multiple stator pole pairs could be provided for each phase group, although with four phases this is likely unnecessary for most applications.) Each stator pole 156 in the form of an annular disk, specifically as a ring-shaped armature yoke 157 with a plurality (e.g., six) salient pole pieces 158 extending radially inward from the outer ring of the armature yoke 157 and terminating at their innermost ends in respective pole shoes 159, one shoe per pole piece. The pole shoes 159 help hold conductive windings (absent in FIG. 14) in place around the pole pieces 158. The stator yoke or core 157 is composed of a soft magnetic material (as described above for FIG. 8), allowing it to be easily magnetized and demagnetized as the stator windings around various stator poles are energized and de-energized in some specified sequence. The stator yoke 157 can be a laminated structure built up from a stack of thin plates. The back-iron or outer portion of the yoke 157 is annular, although not necessarily circular in cross-section. However, the pole shoes 159 have cylindrically concave faces lying on a common circle that is co-axial with the movable rod to present an airgap between rod and shoes that is substantially equidistant around the rod.

The motor's stator includes 4 drive phases (stator groups), each phase A, B, C and D having a pair of stator poles with oppositive windings to create oppositive magnetic fluxes. A winding arrangement without bobbins, like that shown in FIG. 12 for a two-phase motor, can be extended to four-phase motors with two additional conductive winding paths around the pole pieces of the respective pairs of stator poles for the C and D phases. Thus, as seen in FIG. 14, a first A-phase stator group 151 will have the windings around the pole pieces 158 of the first stator pole in a first direction to produce a S magnetic polarity on its pole shoes 159 but have the windings proceed in the opposite direction around the pole pieces of the second stator pole in the group 151 to produce a N magnetic polarity on its shoes.

Each group will also have a magnetically permeable back spacer (not shown in FIG. 14, but which are like the spacers 136 and 139 in FIG. 13), so that the center-to-center longitudinal spacing of the two stator poles in group 151 will be equal to one-half rod pitch and to complete the magnetic circuit whenever that phase group is energized. Each of the pairs 152-154 of stator poles are similarly constructed for the other phases. For a four-phase motor, the different stator phase groups 151-154 need to be separated so that the center-to-center longitudinal distance between stator poles of adjacent phases equals five-eighths rod pitch. With that spacing, one full step will equal one-eighth rod pitch, which is one-half of a rod permanent magnet or rod spacer width. As with the two-phase motor, the adjacent groups can have non-magnetic separators like the separator 141 in FIG. 13, but now three in number, to ensure the appropriate distance between the four groups.

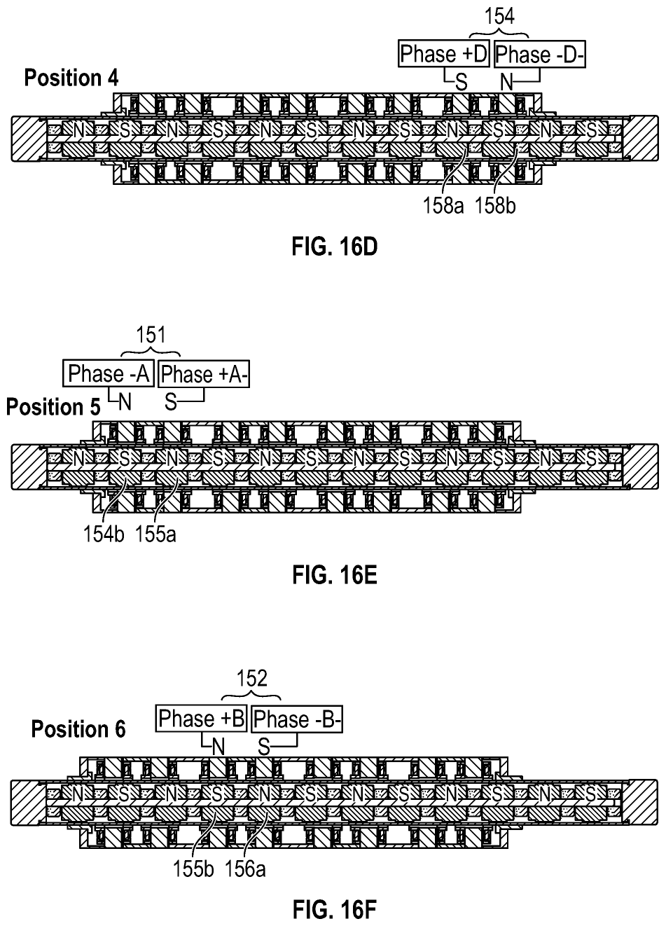

With reference to FIG. 15, the movable rod or shaft will experience different holding and detent torques as a function of the rod's longitudinal position, where the full detent step positions A, B, C, D, A−, B−, C− and D− are distributed at successive one-eighth pitches across the full rod pitch R. In a four-phase linear stepping motor, the holding force 161 (shown here when the B phase stator pair is energized) has a periodicity along the rod equal to the rod pitch R, while the detent force 162 is a fourth harmonic with a periodicity equal to R/4. The detent positions ensure that precise full step (and half-step) positions are provided without the need for any position encoder feedback system. The linear stepping motor can operate as an open loop system.

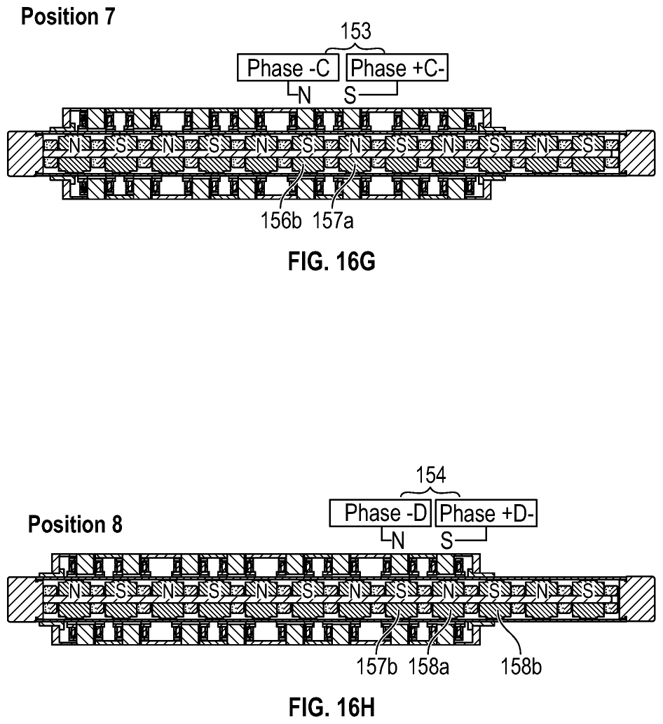

With reference to FIGS. 16A-16H, eight successive full step positions of a four-phase motor are shown. In FIG. 16A, the phase-A group 151 is energized, with the first of the two stator poles presenting a S magnetic polarity on its pole shoes facing the rod and the second of the two stator poles presenting a N magnetic polarity on its pole shoes. The corresponding rod spacers 155a and 155b with respective N and S polarities are seen to be aligned with the phase-A group 151 of stator poles. In FIG. 16B, the phase-B stator group 152 is energized, again with the first stator pole of that group presenting a S magnetic polarity and the second stator pole presenting a N magnetic polarity to the aligned rod spacers 156a and 156b. A comparison of FIGS. 16A and 16B will show that the rod spacers 155a and 155b have stepped by one-eighth rod pitch (one-half of a rod spacer width) relative to its original position. In FIG. 16C, the phase-C stator group 153 is energized and, after a further one-eighth rod pitch step, corresponding rod spacers 157a and 157b align with the stator poles of group 153. In FIG. 16D, the phase-D stator group 154 is energized and the rod spacers 158a and 158b now align with the corresponding stator poles of that group.

In FIG. 16E, the phase-A stator group 151 is again energized, but this time with a reversed current direction. Accordingly, the first of the stator pole pair now presents a N magnetic polarity (instead of the S polarity of FIG. 16A) while the second of the stator pole pair presents a S magnetic polarity. The rod spacer 155a has stepped so that it now aligns with the second (rather than the first) stator pole of the group 151 and a rod spacer 154b aligns with the first stator pole of that group. Continuing, in FIG. 16F, the phase-B stator group 152 is energized with reversed current direction and the pair of stator poles in that group align with rod spacers 155b and 156a. In FIG. 16G, the phase-C stator group 153 is energized with reversed current direction and its stator poles align with rod spacers 156b and 157a. In FIG. 16H, the phase-D stator group 154 is energized with reversed current direction and aligns with rod spacers 157b and 158a. The rod spacer 158b now extends beyond the stator, having shifted seven-eighths of a rod pitch. Energizing the phase-A group 151 with forward current direction would complete the stepping to one rod pitch, provided the stator end cap 157 with bronze bushing 158 and the rod end cap 169 permit it.

Although FIGS. 16A-16H illustrate only full step positions, corresponding half-step positions are possible with energized pairs of phase groups, in the sequence A, AB, B, BC, C, CD, D, D⁻A, ⁻A, ⁻A⁻B, ⁻B, ⁻B⁻C, ⁻C, ⁻C⁻D, ⁻D, ⁻DA, A, . . . , as far as the physical limits of the rod within the stator permit. If desired, with control over the relative applied current amplitudes between two energized phase groups, micro-stepping is possible. In any case, servo position control is unnecessary in this stepping motor because of the rod step positions supplied by the detent torque.

1. A linear stepping motor, comprising:
a rod movable in a first longitudinal direction and having pairs of N-S magnetically opposed permanent magnets longitudinally alternating with magnetically permeable spacer disks between each of the magnets, the permanent magnets and spacer disks all having the same longitudinal width, the rod having a rod pitch equal to twice the permanent magnet width plus twice the disk width; and
a longitudinal linear stator separated from the rod in a second transverse direction by an air gap, the stator having a longitudinal stack of stator groups, each stator group associated with a drive phase and having pairs of stator poles with electromagnetic coils of opposite polarity, the pairs of stator poles in a stator group being longitudinally separated by a center-to-center distance equal to one-half rod pitch, adjacent stator poles in different stator groups of different drive phase being separated by a center-to-center distance equal to [(n+1)/2n] rod pitch, where n is the number of motor drive phases.

2. The linear stepping motor as in claim 1, wherein the motor is a two-phase motor, n=2, the center-to-center separation between adjacent poles of different stator groups being three-fourths rod pitch.

3. The linear stepping motor as in claim 1, wherein the motor is a four-phase motor, n=4, the center-to-center separation between adjacent poles of different stator groups being five-eighths rod pitch.

4. The linear stepping motor as in claim 1, wherein there is at least one stator group for each drive phase.

5. The linear stepping motor as in claim 4, wherein there are a specified multiple of stator groups for each drive phase.

6. The linear stepping motor as in claim 1, wherein the rod is in the form of a hollow tube with the permanent magnets and spacer disks stacked alternately within the tube, the permanent magnets alternating in magnetic polarity longitudinal direction such that each spacer disk faces the same magnetic polarity from both adjacent magnets.

7. The linear stepping motor as in claim 6, wherein the hollow tube, permanent magnets and spacer disks have circular cross-section.

8. The linear stepping motor as in claim 1, wherein the spacer disks are composed of magnetically permeable steel.

9. The linear stepping motor as in claim 1, wherein each stator pole is in the form of a generally annular disk armature yoke with a plurality of radially inward projecting salient pole pieces terminating in pole shoes and with conductive windings around those salient pole pieces, the windings in any given stator pole being in a consistent direction around the pole pieces such that the electromagnetic coils so formed when energized by an electric drive current direct a common magnetic polarity radially through the pole pieces of that stator pole onto the pole shoes to interact across the air gap with the rod.

10. The linear stepping motor as in claim 9, wherein each annular disk armature yoke has six salient pole pieces.

11. The linear stepping motor as in claim 9, wherein conductive windings for the pair of stator poles of a stator group proceed successively in a consistent direction around each pole piece of a first stator pole of the group and then proceed successively in a reverse direction around each pole piece of a second stator pole of the group.

12. A two-phase linear stepping motor, comprising:
a rod movable in a first longitudinal direction and having pairs of N-S magnetically opposed permanent magnets longitudinally alternating with magnetically permeable spacer disks between each of the magnets, the permanent magnets and spacer disks all having the same longitudinal width, the rod having a rod pitch equal to twice the permanent magnet width plus twice the disk width; and
a longitudinal linear stator separated from the rod in a second transverse direction by an air gap, the stator having a longitudinal stack of stator groups, each stator group associated with one of two drive phases and having pairs of stator poles with electromagnetic coils of opposite polarity, the pairs of stator poles in a stator group being longitudinally separated by a center-to-center distance equal to one-half rod pitch, adjacent stator poles in different stator groups of different drive phase being separated by a center-to-center distance equal to three-fourths rod pitch, each stator pole being in the form of a generally annular disk armature yoke with a plurality of radially inward projecting salient pole pieces terminating in pole shoes and with conductive windings around those salient pole pieces, the windings in any given stator pole being in a consistent direction around the pole pieces such that the electromagnetic coils so formed when energized by an electric drive current direct a common magnetic polarity radially through the pole pieces of that stator pole onto the pole shoes to interact across the air gap with the rod.

13. The linear stepping motor as in claim 12, wherein conductive windings for the pair of stator poles of a stator group proceed successively in a consistent direction around each pole piece of a first stator pole of the group and then proceed successively in a reverse direction around each pole piece of a second stator pole of the group.

14. The two-phase linear stepping motor as in claim 12, wherein the rod is in the form of a hollow tube with the permanent magnets and spacer disks stacked alternately within the tube, the permanent magnets alternating in magnetic polarity longitudinal direction such that each spacer disk faces the same magnetic polarity from both adjacent magnets.

15. The linear stepping motor as in claim 14, wherein the hollow tube, permanent magnets and spacer disks have circular cross-section.

16. The linear stepping motor as in claim 12, wherein the spacer disks are composed of magnetically permeable steel.

17. A four-phase linear stepping motor, comprising:
a rod movable in a first longitudinal direction and having pairs of N-S magnetically opposed permanent magnets longitudinally alternating with magnetically permeable spacer disks between each of the magnets, the permanent magnets and spacer disks all having the same longitudinal width, the rod having a rod pitch equal to twice the permanent magnet width plus twice the disk width; and
a longitudinal linear stator separated from the rod in a second transverse direction by an air gap, the stator having a longitudinal stack of stator groups, each stator group associated with a drive phase and having pairs of stator poles with electromagnetic coils of opposite polarity, the pairs of stator poles in a stator group being longitudinally separated by a center-to-center distance equal to one-half rod pitch, adjacent stator poles in different stator groups of different drive phase being separated by a center-to-center distance equal to five-eighths rod pitch, each stator pole being in the form of a generally annular disk armature yoke with a plurality of radially inward projecting salient pole pieces terminating in pole shoes and with conductive windings around those salient pole pieces, the windings in any given stator pole being in a consistent direction around the pole pieces such that the electromagnetic coils so formed when energized by an electric drive current direct a common magnetic polarity radially through the pole pieces of that stator pole onto the pole shoes to interact across the air gap with the rod.

18. The linear stepping motor as in claim 17, wherein conductive windings for the pair of stator poles of a stator group proceed successively in a consistent direction around each pole piece of a first stator pole of the group and then proceed successively in a reverse direction around each pole piece of a second stator pole of the group.

19. The two-phase linear stepping motor as in claim 17, wherein the rod is in the form of a hollow tube with the permanent magnets and spacer disks stacked alternately within the tube, the permanent magnets alternating in magnetic polarity longitudinal direction such that each spacer disk faces the same magnetic polarity from both adjacent magnets.

20. The linear stepping motor as in claim 19, wherein the hollow tube, permanent magnets and spacer disks have circular cross-section.

21. The linear stepping motor as in claim 17, wherein the spacer disks are composed of magnetically permeable steel.
